(19) United States
(12) Patent Application Publication
(10) Pub. No.: US 2019/0078364 A1
(43) Pub. Date: Mar. 14, 2019

(54) LOCKING HINGE

(71) Applicant: Steven Murrill, Theodore, AL (US)

(72) Inventor: Steven Murrill, Theodore, AL (US)

(21) Appl. No.: 15/703,978

(22) Filed: Sep. 13, 2017

(51) Int. Cl. E05D 5/12; E05D 3/06

(52) U.S. Cl. CPC E05D 5/125; E05D 3/06

(57) ABSTRACT

A locking hinge is provided. The hinge includes axially aligned pins attached to a first leaf and corresponding spaced knuckles attached to a second leaf. Each pin is designed for one-way insertion into one of the corresponding knuckles. Once inserted, each pin is locked in an axially fixed position relative to each knuckle.

### FIELD OF THE INVENTION

A preferred implementation of the present invention refers generally to a locking hinge.

### BACKGROUND

Many different types of hinges are utilized for various applications, but hinges typically comprise at least three components, which include interlocking knuckles attached to two separate leaves as well as a pin that is inserted into the interlocking knuckles. The pin defines an axis of rotation, and the leaves of the hinge rotate about the axis of rotation within a limited angle of rotation. Such a hinge may be installed by aligning the knuckles of each of the leaves in an interlocking position and inserting the pin through all of the aligned knuckles. To disassemble the hinge, the pin may be removed to separate the leaves.

However, in some cases, it may be advantageous to prevent easy disassembly of a hinge. For instance, in certain industrial applications, storage containers may be required to remain closed at all times except when the contents of the container must be accessed. In this case, it may be advantageous to utilize a hinge that cannot be easily disassembled to attach a lid to the container. In addition, it may be advantageous to utilize a hinge having fewer components than currently available hinges for ease of installation and to reduce manufacturing costs.

Accordingly, a need exists in the art for a hinge that cannot be easily disassembled. Furthermore, a need exists in the art for a hinge that utilizes fewer components compared to known hinges.

### SUMMARY

In one aspect, a locking hinge is provided. The hinge comprises one or more mating pins and corresponding knuckles that lock in an axially fixed position relative to each other when mated together. To install the hinge for proper functioning, each pin is inserted into a corresponding knuckle. Each pin is configured for one-way insertion such that the pin cannot be removed by withdrawing the pin. Thus, once the corresponding pins and knuckles are locked in place, the hinge may not be easily disassembled. When mated together, each pin and knuckle may freely rotate back and forth relative to each other within a defined angle of rotation. Each pin is attached to a first leaf of the hinge, and each knuckle is attached to a second leaf of the hinge. Because the one or more pins are attached to one leaf of the hinge, the hinge may be constructed utilizing fewer components compared to currently known hinges that utilize a separate pin unattached to any other component.

In a preferred embodiment, the hinge comprises a plurality of axially aligned pins attached to a first leaf and a plurality of spaced knuckles attached to a second leaf, wherein each knuckle corresponds to a respective pin. Each pin has a body and a head having a diameter greater than a diameter of the body, and each knuckle defines a passageway axially aligned with and sized to receive the head of one of the pins therein. In addition, each knuckle has an edge sized and positioned to contact a bottom surface of the head of one of the pins after insertion of the pin into the knuckle. Once the pin is inserted, the edge prevents axial movement of the pin in a direction opposite a direction of insertion.

The passageway of each knuckle is preferably an open passageway, and each knuckle preferably has a grooved notch extending along a length of the knuckle in an axial direction. The notch allows the knuckle to flex outwardly in a radial direction to an extent sufficient to allow the head of the pin to pass through the knuckle due to a slight expansion in the size of the passageway. Thus, each knuckle and the head of each corresponding pin are sized such that an exterior surface of the head contacts an interior surface of the knuckle when the pin is inserted into the knuckle. Force is applied to the pin to insert the head of the pin through the knuckle and past the edge of the knuckle. As the head of the pin passes through the knuckle, the passageway within the knuckle expands slightly to allow passage. Once the head of the pin is inserted past the edge of the knuckle, the knuckle returns to its original shape before flexing such that the edge of the knuckle prevents removal of the pin by withdrawing the pin. The pin is then axially locked in a fixed position, and the pin and knuckle may freely rotate back and forth relative to each other within a defined angle of rotation.

In a preferred embodiment, the first leaf and the plurality of axially aligned pins attached thereto are formed from a unitary piece of material, and the second leaf and the plurality of spaced knuckles attached thereto are additionally formed from a second, separate unitary piece of material. Preferably, the separate pieces are each injection molded. Utilizing injection molded, unitary pieces of material to form each respective piece of the hinge allows the hinge to be constructed from only two separate parts, which provides simple installation of the hinge and additionally may provide a reduction of manufacturing costs.

The foregoing summary has outlined some features of the device of the present disclosure so that those skilled in the pertinent art may better understand the detailed description that follows. Additional features that form the subject of the claims will be described hereinafter. Those skilled in the pertinent art should appreciate that they can readily utilize these features for designing or modifying other structures for carrying out the same purposes of the device disclosed herein. Those skilled in the pertinent art should also realize that such equivalent designs or modifications do not depart from the scope of the systems and methods of the present disclosure.

### DESCRIPTION OF THE DRAWINGS

These and other features, aspects, and advantages of the present invention will become better understood with regard to the following description, appended claims, and accompanying drawings where:

FIG. 1 shows a perspective view of a container comprising a hinge leaf and spaced hinge knuckles attached thereto in accordance with the present disclosure.

FIG. 1A shows a partial perspective view of a container comprising a hinge leaf and spaced hinge knuckles attached thereto in accordance with the present disclosure.

FIG. 2 shows a top plan view of a container lid comprising a hinge leaf and hinge pins attached thereto in accordance with the present disclosure.

FIG. 3 shows a top plan view of a container and lid before connecting the lid to the container via a hinge in accordance with the present disclosure.

FIG. 4 shows a top plan view of a container and lid after connecting the lid to the container via a hinge with the lid open in accordance with the present disclosure.

FIG. 5 shows a top plan view of a container and lid after connecting the lid to the container via a hinge with the lid closed in accordance with the present disclosure.

FIG. 6 shows a cross-sectional view of a hinge connecting a lid to a container as seen along line A-A in FIG. 5 in accordance with the present disclosure.

FIG. 7 shows partial perspective view of a container and lid after connecting the lid to the container via a hinge with the lid closed in accordance with the present disclosure.

FIG. 8 shows a partial perspective view of a container comprising a hinge leaf and spaced hinge knuckles attached thereto in accordance with the present disclosure.

FIG. 9 shows a partial perspective view of a container comprising a hinge leaf and spaced hinge knuckles attached thereto in accordance with the present disclosure.

FIG. 10 shows a partial top plan view of a container comprising a hinge leaf and hinge pins attached thereto in accordance with the present disclosure.

### DETAILED DESCRIPTION

In the Summary above and in this Detailed Description, and the claims below, and in the accompanying drawings, reference is made to particular features, including method steps, of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with/or in the context of other particular aspects of the embodiments of the invention, and in the invention generally.

The term “comprises” and grammatical equivalents thereof are used herein to mean that other components, steps, etc. are optionally present. For example, a system “comprising” components A, B, and C can contain only components A, B, and C, or can contain not only components A, B, and C, but also one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

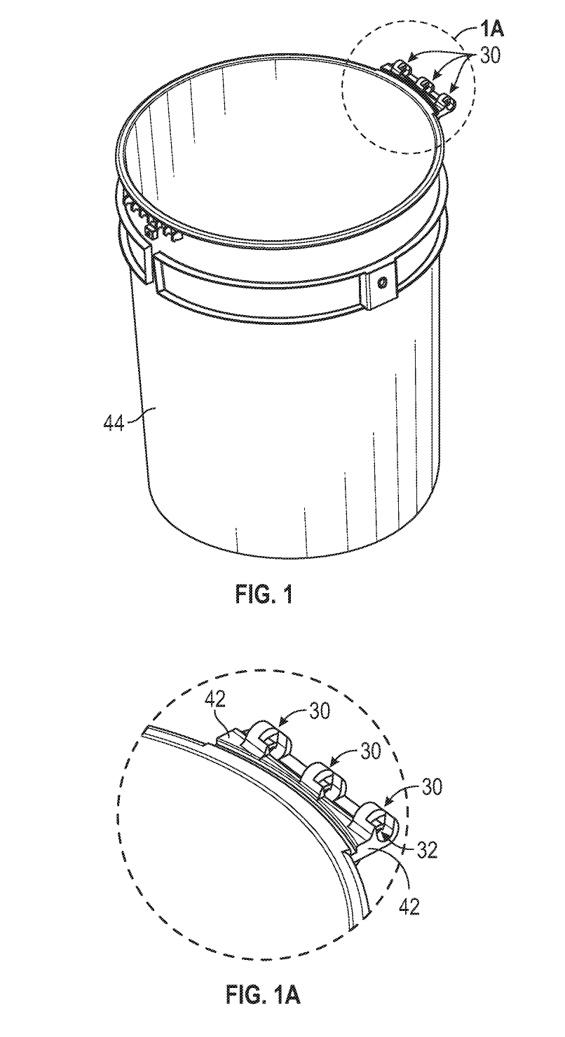

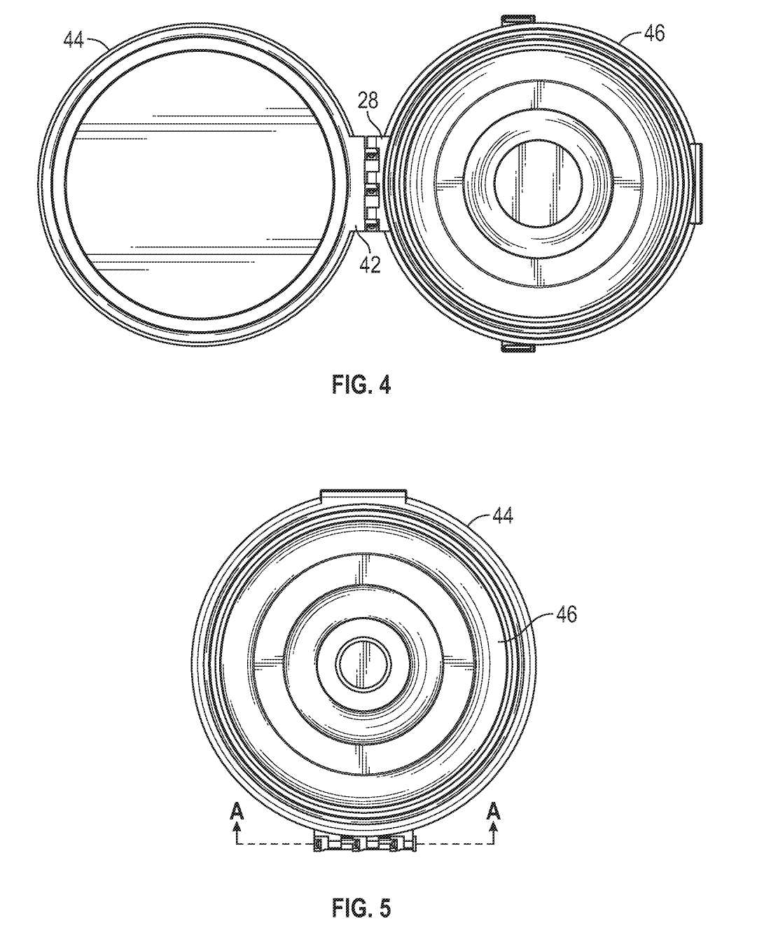

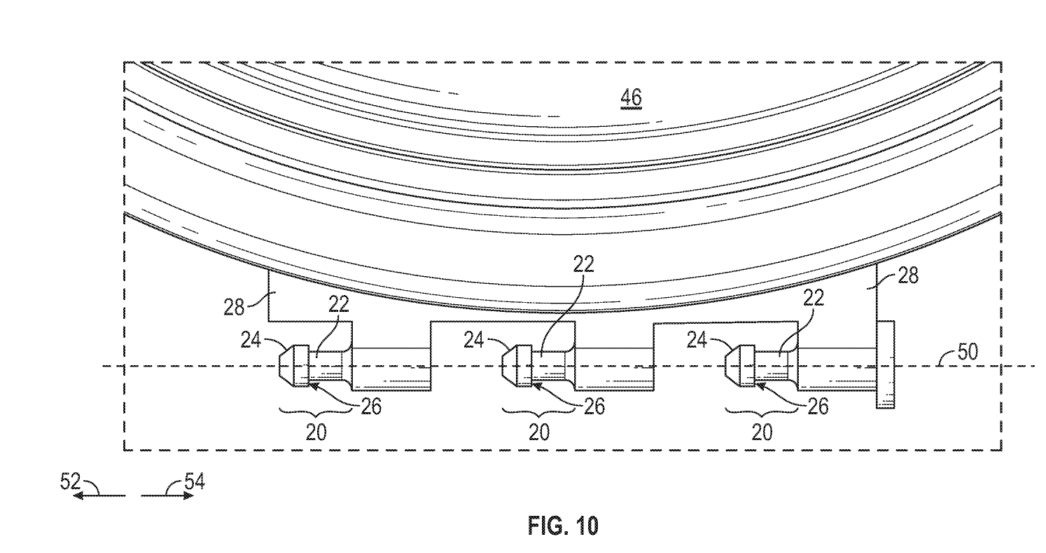

In one aspect, a locking hinge is provided. The hinge comprises one or more mating pins 20 and one or more corresponding knuckles 30 that lock in an axially fixed position relative to each other when mated together. FIG. 10 illustrates a part of the hinge having three pins 20, and FIGS. 1 and 1A illustrate a part of the hinge having three spaced knuckles 30, wherein each respective knuckle 30 corresponds to one individual pin 20. To install the hinge for proper functioning, each pin 20 is inserted into a corresponding knuckle 30. FIG. 3 illustrates a hinge prior to insertion of the pins 20 into the corresponding knuckles 30, and FIG. 4 illustrates the hinge after complete insertion of each pin 20 into each corresponding knuckle 30. Each pin 20 is configured for one-way insertion such that the inserted pin 20 cannot be removed by withdrawing the pin 20. Thus, once each of the corresponding pins 20 and knuckles 30 are locked in place, as best seen in FIGS. 4 and 7, the hinge may not be disassembled by withdrawing each of the pins 20 from each respective knuckle 30. When mated together, each pin 20 and each knuckle 30 may freely rotate back and forth relative to each other within a defined angle of rotation. Each pin 20 is attached to a first leaf 28 of the hinge, and each knuckle 30 is attached to a second leaf 42 of the hinge. Because the one or more pins 20 are attached to one leaf 28 of the hinge, the hinge may be constructed utilizing fewer components compared to currently known hinges that utilize a separate pin unattached to any other component.

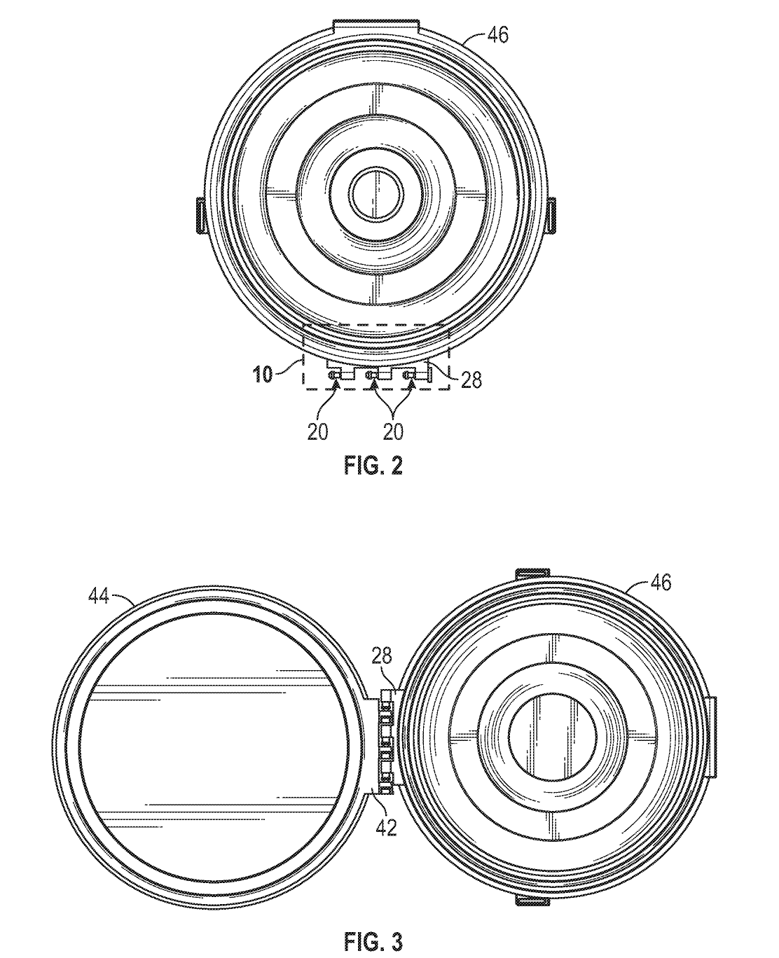

FIGS. 1-10 show an illustrative example of an application utilizing the present hinge. In this example, the first leaf 28 is integrally attached to a lid 46, and the second leaf 42 is integrally attached to a container 44 that may be closed by rotating the lid 46 via the hinge connecting the lid 46 to the container 44. It should be understood that the application of a container 44 and a lid 46 that opens and closes as illustrated in the figures is illustrative only and that the present hinge may be utilized in any application requiring rotational movement of components via a hinge. In addition, although the figures illustrate the first leaf 28 and the second leaf 42 of the hinge each integrally attached to separate components (i.e., the container 44 and the lid 46) that rotate relative to each other, it should be understood that each of the leaves 28 and 42 may be detached from specific components and may be configured for attachment to a desired component depending on the application. For instance, the leaves 28 and 42 may have one or more openings therethrough sized such that the leaves 28 and 42 can be attached to a component using fasteners such as threaded screws or nuts and bolts.

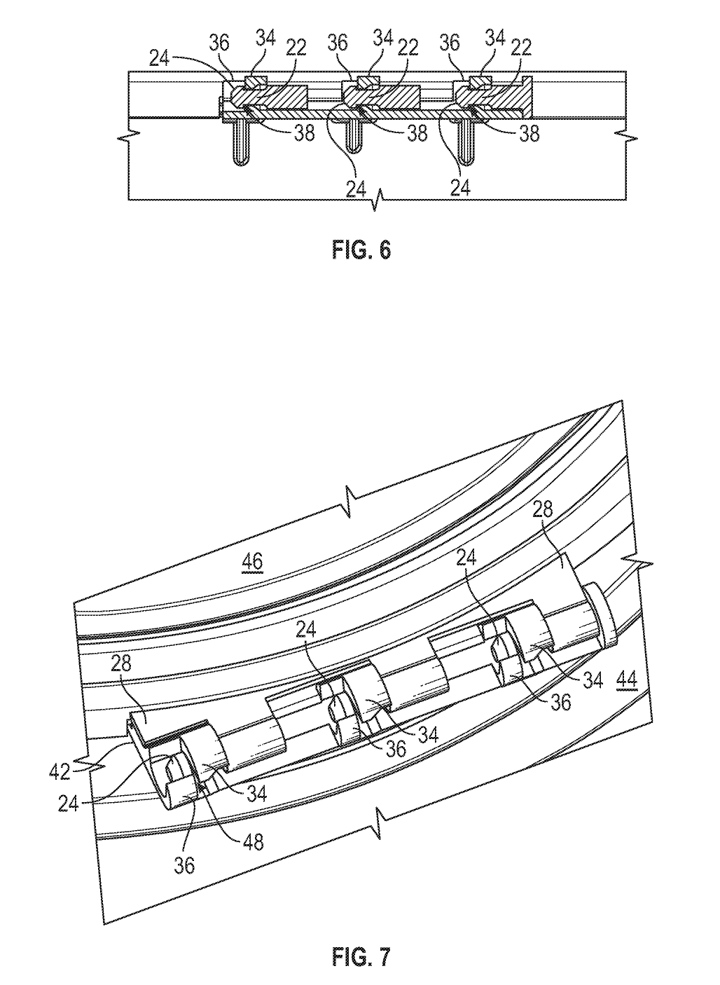

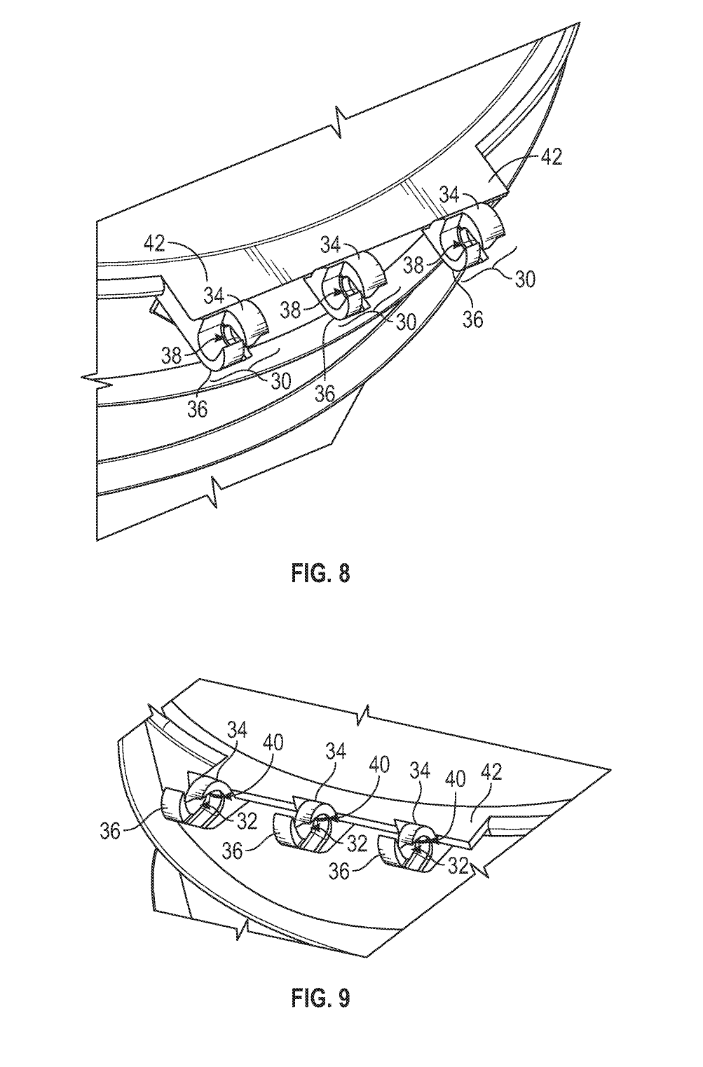

In a preferred embodiment, as best seen in FIGS. 8-10, the hinge comprises a plurality of axially aligned pins 20 attached to a first leaf 28 and a plurality of spaced knuckles 30 attached to a second leaf 42, wherein each knuckle 30 corresponds to a respective pin 20. As shown in FIGS. 8-10, the hinge preferably comprises three axially aligned pins 20 and three corresponding knuckles 30. The pins 20 are aligned along a fixed axis of rotation 50, and the first leaf 28 extends outwardly from the pins 20 in a lateral direction. As best seen in FIG. 10, each pin 20 has a body 22 and a head 24 having a diameter greater than a diameter of the body 22. As shown in FIGS. 8 and 9, each knuckle 30 defines a passageway 32 axially aligned with and sized to receive the head 24 of one of the pins 20 therein. In addition, as best seen in FIGS. 6 and 8, each knuckle 30 has an edge 38 sized and positioned to contact a bottom surface 26 of the head 24 of one of the pins 20 after insertion of the pin 20 into the knuckle 30, as shown in FIG. 7. Once the pin 20 is inserted, direct contact between the bottom surface 26 of the head 24 of the pin 20 and the edge 38 prevents axial movement of the pin 20 in a direction 54 opposite a direction 52 of insertion.

As shown in FIG. 9, the passageway 32 defined by each knuckle 30 is preferably an open passageway 32. As used herein, an open passageway refers to a passageway that is open (i.e., not closed around a circumferential perimeter of the passageway) along an axial length of the passageway that is aligned with the axis of rotation 50 when the hinge components are fully installed, as shown in FIG. 7. Thus, each knuckle 30 preferably has an open side along the length of the passageway 32. In an alternative embodiment, the passageway 32 may be closed along its length. The passageway 32 is also open at one end to allow insertion of a pin 20 into the passageway, though the passageway may optionally be open or blind at the opposite end. In a preferred embodiment, both ends of the passageway 32 are open.

In addition, as best seen in FIGS. 8 and 9, each individual knuckle 30 preferably comprises a first semicircular element 34 and a second semicircular element 36 adjacent to the first element. The two adjacent semicircular elements 34 and 36 define the passageway 32 along its axial length. As used herein, a “semicircular element” refers to a component of a hinge knuckle having an inner surface that defines a passageway that is at least partially open along an axial length of the passageway and is not limited to an element having a shape of a half of a circle. As seen in FIG. 7, the adjacent semicircular elements 34 and 36 are preferably positioned such that a small gap 48 exists between the elements. This gap 48 allows the knuckles 30 and leaf 42 to which the knuckles are attached to be formed from a unitary piece of material by an injection molding process, as discussed below.

As seen in FIGS. 8 and 9, each element 34 and 36 of each knuckle 30 preferably has an opening along the axial length of the passageway 32 defined by the elements 34 and 36, and the openings of the two elements 34 and 36 are preferably not aligned. For instance, the opening of the first knuckle element 34 faces in a lateral direction opposite the second leaf 42 to which the knuckles 30 are attached, and the opening of the second knuckle element 36 faces in an upward direction perpendicular to the second leaf 42 as shown in FIG. 9. Thus, the open sides along the axial length of the elements 34 and 36 are not aligned with each other.

In a preferred embodiment, as best shown in FIG. 9, each knuckle 30 preferably has a grooved notch 40 extending along a length of the knuckle 30 in an axial direction. As shown in FIG. 9, the notch 40 is preferably formed in one side of the first semicircular element 34. The notch 40 allows the element 34 of each knuckle 30 to slightly flex outwardly in a radial direction. The element 34 flexes to an extent that causes the size of the passageway 32 to expand sufficiently to allow the head 24 of the pin 20 to pass through the first element 34 of the knuckle 30 and into a segment of the passageway 32 defined by the second element 36. The first element 34 (into which the head 24 of the pin 20 is first inserted) of each knuckle 30 and the head 24 of each corresponding pin 20 are sized such that an exterior surface of the head 24 contacts an interior surface of the element 34 when the pin 20 is inserted into the passageway 32 defined by the knuckle 30. Force is applied to the pin 20 to forcibly insert the head 24 of the pin through the first element 34 of the knuckle 30. As seen in FIG. 10, the head 24 of each pin 20 preferably has a rounded or sloped exterior surface to facilitate insertion of the pin 20 by forcing the element 34 to flex outwardly when inserting the head 24 of the pin 20 through the segment of the passageway 32 defined by the first element 34.

As shown in FIG. 8, each knuckle 30 has an edge 38 preferably positioned between the first 34 and second elements 36 of the knuckle. The edge 38 may be formed by the first semicircular element 34 having a slightly smaller internal diameter than the adjacent second element 36. The head 24 of the pin 20 is inserted into the passageway 32 past the edge 38 so that the head 24 of the pin 20 generally rests within the second semicircular element 36, as shown in FIG. 7. The internal diameter of the second element 36 is slightly larger than an external diameter of the head 24 such that the head 24 may freely rotate within the element 36. As the head 24 of the pin 20 passes through the first element 34 of the knuckle 30, the element 34 flexes radially outward so that the size of the passageway 32 expands slightly to allow the head 24 to pass through. Once the head 24 of the pin 20 is inserted past the edge 38, the first element 34 returns to the original shape of the element before flexing. The edge 38 of the element 34 may then contact the bottom surface 26 of the head 24 of the pin 20, thereby preventing removal of the pin 20 by withdrawing the pin 20. The bottom surface 26 of the head 24 extends around the circumference of the head 24. FIG. 6 shows a cross section of the hinge with the head 24 of each pin 20 fully inserted and resting within the second element 36 of each knuckle 30. As seen in FIG. 6, the edge 38 may be formed by a circumference of the first semicircular element 34 such that the edge 38 may contact the bottom surface 26 of the head 24 around a portion of the circumference of the head 26 on opposing sides of the head 24, e.g., at both an upper side and a lower side of the head 24 of the pin 20 when the pin is positioned horizontally as shown in FIG. 6.

To install the hinge, each of the pins 20 is positioned in axial alignment with each of the respective knuckles 30, as shown in FIG. 3. Each pin 20 is then simultaneous inserted into each respective knuckle 30, as shown in FIG. 4, until the head of each pin 20 moves past the edge 38 of the first element 34. The edge 38 then prevents axial movement of the pin 20 in a direction 54 opposite the direction 52 of insertion of the pin 20. In addition, the first leaf 28 is preferably shaped such that a laterally extending portion of the first leaf 28 that is directly attached to a pin 20 may prevent axial movement of the pin 20 in the direction 52 of insertion by contacting a corresponding first element 34 of the knuckle 30. In addition, the unaligned configuration of the side openings along an axial length of each of the first and second elements 34 and 36 prevents forcible removal of the pins 20 from the knuckles 30 in a lateral direction through the side openings.

The length of the body 22 of each pin 20 is preferably sized to be slightly longer than the axial length of the first element 34 so that each pin 20 may move back and forth a small distance within each knuckle 30 within an allowable tolerance in order to provide free rotation between the pins 20 and knuckles 30. Once fully inserted into a knuckle 30, each pin 20 is locked in an axially fixed position (excepting slight back and forth movement within a knuckle) relative to the knuckle 30, and the pin 20 and knuckle 30 may freely rotate back and forth relative to each other within a defined angle of rotation. In the illustrative container 44 and lid 46 application shown in the figures, the knuckles 30 remain stationary as the pins 20 rotate within the knuckles 30 in order to open and close the lid 46 of the container 44. In other applications, the pins 20 may remain stationary as the knuckles 30 rotate about the pins 20.

In a preferred embodiment, the components of the hinge, including the leaves 28 and 42, the pins 20, and the knuckles 30, are made of a plastic material such as high-density polyethylene or a similar type of thermoplastic or thermosetting polymer. Alternatively, the components of the hinge may be constructed of any suitable metal or metal alloy. The material of construction is preferably a relatively hard and durable material that has a small amount of flexibility to allow the knuckles 30 to flex slightly when inserting the pins 20 but that returns to and retains its original shape after insertion of the pins 20. In alternative embodiments, different components, such as the first element 34, may be made of different materials. Once the pins 20 are fully inserted, the pins 20 cannot be withdrawn by pulling the pins 20 in the opposite direction 54 of the direction 52 of insertion. The present hinge is designed such that the pins 20 become permanently locked in place once inserted into the knuckles 30. As such, although it may be possible to remove the pins 20 by prying open first element 34 of the knuckle 30 using a tool, the construction material of the knuckles as well as the shape and dimensions of the element 34 prevent removal of the pins without causing damage to the components of the hinge.

A method of manufacturing a hinge as described above is also provided. To make the hinge, two separate parts are injection molded. The first part comprises the first leaf 28 and the axially aligned pins 20 attached thereto, and the second part comprises the second leaf 42 and the spaced knuckles 30 attached thereto. Each of the two parts is formed from a unitary piece of material through the process of injection molding. As used herein, injection molding includes the process of die-casting metal material. In a preferred embodiment, each knuckle 30 defines a passageway 32 that is open and includes adjacent elements 34 and 36 having a gap 48 between them. The open sides of the elements 34 and 36 and the gap 48 between elements provide a single knuckle/leaf part that may be injection molded as a unitary piece. Alternatively, a piece having solid knuckles (without a passageway) may be molded, and a closed passageway may be formed by drilling a hole through each of the solid knuckles. In this embodiment, one or more axially extending grooves may be formed in the interior of each knuckle to allow each knuckle to radially expand outwardly so that the head of a pin may be inserted into the knuckle.

Utilizing injection molded, unitary pieces of material to form the two individual parts of the hinge allows the hinge to be manufactured in a simple, cost-effective manner. In addition, utilizing only two separate parts provides simple installation of the hinge that does not require the use of a separate pin.

It is understood that versions of the present disclosure may come in different forms and embodiments. Additionally, it is understood that one of skill in the art would appreciate these various forms and embodiments as falling within the scope of the invention as disclosed herein.

What is claimed is:

1) A hinge comprising a mating pin and knuckle, wherein the pin is configured for one-way insertion into the knuckle such that the pin is locked in an axially fixed position relative to the knuckle when mated with the knuckle, and wherein the pin and knuckle freely rotate back and forth relative to each other within a defined angle of rotation when the pin is mated with the knuckle.

2) The hinge of claim 1, wherein the pin has a body and a head having a diameter greater than a diameter of the body.

3) The hinge of claim 2, wherein the knuckle defines a passageway axially aligned with and sized to receive the head of the pin therein, wherein the knuckle has an edge sized and positioned to contact a bottom surface of the head of the pin after insertion of the pin into the knuckle, and wherein the edge prevents axial movement of the pin in a direction opposite a direction of insertion.

4) The hinge of claim 1, wherein the pin is attached to a first leaf and the knuckle is attached to a second leaf.

5) The hinge of claim 4, wherein the first leaf and the pin attached thereto are formed from a unitary piece of material.

6) The hinge of claim 5, wherein the unitary piece of material is injection molded.

7) The hinge of claim 4, wherein the second leaf and knuckle attached thereto are formed from a unitary piece of material.

8) The hinge of claim 7, wherein the unitary piece of material is injection molded.

9) A hinge comprising a plurality of axially aligned pins attached to a first leaf and a plurality of spaced knuckles attached to a second leaf, wherein each knuckle corresponds to a respective pin, wherein each pin has a body and a head having a diameter greater than a diameter of the body, wherein each knuckle defines a passageway axially aligned with and sized to receive the head of one of the plurality of pins therein, wherein each knuckle has an edge sized and positioned to contact a bottom surface of the head of one of the plurality of pins after insertion of the pin into the knuckle, and wherein the edge prevents axial movement of the pin in a direction opposite a direction of insertion.

10) The hinge of claim 9, wherein the first leaf and the plurality of axially aligned pins attached thereto are formed from a unitary piece of material.

11) The hinge of claim 10, wherein the unitary piece of material is injection molded.

12) The hinge of claim 9, wherein the second leaf and the plurality of spaced knuckles attached thereto are formed from a unitary piece of material.

13) The hinge of claim 12, wherein the unitary piece of material is injection molded.

14) The hinge of claim 9, wherein each knuckle defines an open passageway.

15) The hinge of claim 14, wherein each knuckle has a grooved notch extending along a length of the knuckle in an axial direction, wherein the notch allows the knuckle to flex to an extent sufficient to allow the head of one of the plurality of pins to pass therethrough.

16) The hinge of claim 14, wherein each knuckle comprises two adjacent semicircular elements having openings that are not aligned, wherein one of the elements has a grooved notch extending along a length of the element in an axial direction, wherein the notch allows the element to flex to an extent sufficient to allow the head of one of the plurality of pins to pass therethrough.

17) A method of manufacturing a hinge, said method comprising the steps of:
injection molding a first unitary piece of material comprising a plurality of axially aligned pins attached to a first leaf, wherein each pin has a body and a head having a diameter greater than a diameter of the body; and
injection molding a second unitary piece of material comprising a plurality of spaced knuckles attached to a second leaf, wherein each knuckle defines a passageway axially aligned with and sized to receive the head of one of the plurality of pins therein, wherein each knuckle has an edge sized and positioned to contact a bottom surface of the head of one of the plurality of pins after insertion of the pin into the knuckle, and wherein the edge prevents axial movement of the pin in a direction opposite a direction of insertion.

18) The method of claim 17, wherein each knuckle defines an open passageway.

19) The method of claim 18, wherein each knuckle has a grooved notch extending along a length of the knuckle in an axial direction, wherein the notch allows the knuckle to flex to an extent sufficient to allow the head of one of the plurality of pins to pass therethrough.

20) The method of claim 18, wherein each knuckle comprises two adjacent semicircular elements having openings that are not aligned, wherein one of the elements has a grooved notch extending along a length of the element in an axial direction, wherein the notch allows the element to flex to an extent sufficient to allow the head of one of the plurality of pins to pass therethrough.
